(19) United States
(12) Patent Application Publication
(10) Pub. No.: US 2012/0315604 A1
(43) Pub. Date: Dec. 13, 2012

(54) KIT FOR DECORATING SNOW

(76) Inventor: Della S. Milbank, Westland, MI (US)

(21) Appl. No.: 13/495,959

(22) Filed: Jun. 13, 2012

Related U.S. Application Data
(60) Provisional application No. 61/496,196, filed on Jun. 13, 2011.

(51) Int. Cl. G09B 19/00

(52) U.S. Cl. 434/81

(57) ABSTRACT

A kit for decorating snow that comprises a plurality of uniquely-colored volumes of particulate matter and a plurality of containers for storing and dispensing the particulate matter. Each container has an opening for dispensing the matter, and the opening can be a plurality of holes, an elongated nozzle, or the like. The particulate matter comprises a non-toxic powderized chalk, and can be provided in any number of colors, including the primary colors of red, blue, and yellow. There is also disclosed a method for using the kit to decorate the snow.

### CROSS REFERENCE TO RELATED APPLICATION

This application claims the benefit of U.S. Provisional Application 61/496,196, which was filed on Jun. 13, 2011, the disclosure of which is hereby incorporated by reference.

### BACKGROUND OF THE INVENTION

1. Field of the Invention

The present invention pertains to a kit for decorating snow. More particularly, the present invention pertains to a kit for decorating snow which includes a volume of colored particulate matter and a plurality of containers for dispensing the particulate matter. Even more particularly, the present invention pertains to a plurality of volumes of uniquely-colored particulate matter for disbursement by the containers.

2. Description of the Prior Art

There exists in the prior art various methods and compositions for coloring or decorating snow. For example, U.S. Pat. Nos. 5,165,966 and 5,549,933 to Adams disclose a process of allowing one to paint or draw on snow whereby a coloring agent, such as food coloring, is mixed with a gelling agent (e.g., household gelatin), and applied with a spray or squirt gun. When the gel solution contacts the cold snow, the gel solution quickly sets up and is prevented from dissipating as snow undergoes partial melting. When the snow melts, the gel liquefies and disappears with the runoff water.

U.S. Pat. Nos. 5,711,790 and 5,735,940 to Coller disclose a temporary marking composition for producing colors upon contact with a snow-covered surface. The compositions contain either water-soluble salts or a mixture of water-soluble salts, colorant, and water. The compositions may include a stabilizer, an extender, additional antifreezes, antibacterial or anti-fungus agents, and other ingredients. The extenders can comprise chalk in the amount of 0.25%-3% by weight of the total composition.

In addition, U.S. Pat. No. 7,416,192 to Feller discloses a sled having an aerosol container containing a coloring fluid to allow the user to leave behind a colored trail showing where the sled has gone. The aerosol container is housed in a jacket attached to a movable mounting plate. The tilt actuator of the container is activated by a trigger wire which is attached to a trigger on the sled handle. The coloring fluid is a biodegradable, water-soluble paint which can be provided in a variety of colors.

While the prior art contemplates the use of a colorant for decorating snow in varying degrees, there does not yet exist a product which allows snow (or any other suitable substance, such as sand) to be extensively decorated for purposes of entertainment or recreation.

The present invention, as is detailed hereinbelow, seeks to resolve this issue by providing a kit which includes a plurality of volumes of uniquely-colored particulate matter and a plurality of containers for containing the particulate matter, the containers having a variety of tips or openings for dispensing the particulate matter onto the snow.

### SUMMARY OF THE INVENTION

The present invention provides a kit for decorating an object which generally comprises:
(a) a plurality of volumes of particulate matter, each volume of particulate matter being uniquely-colored; and
(b) a plurality of containers for storing and dispensing the particulate matter, each container having an opening for dispensing the matter therethrough.

Optionally, the particulate matter comprises a non-toxic, colored, powderized chalk.

Optionally, the opening on each container comprises a plurality of holes, an elongated nozzle, or the like.

The present invention also provides a method for decorating an object which generally comprises:
(a) providing a plurality of volumes of particulate matter, each volume of particulate matter being uniquely-colored;
(b) providing a plurality of containers for storing and dispensing the particulate matter, each container having an opening for dispensing the matter therethrough;
(c) selecting a first volume from the plurality of volumes of particulate matter having a particular color to be placed into a first container from the plurality of containers having a particular opening;
(d) placing the first volume of particulate matter into the first container; and
(e) disbursing the first volume of particulate matter out of the first container and onto the object.

Preferably the object is outdoors, and even more preferably, the object is formed from snow or sand.

For a more complete understanding of the present invention, reference is made to the following detailed description and accompanying drawings. In the drawings, like reference characters refer to like parts throughout the views in which:

### BRIEF DESCRIPTION OF THE DRAWINGS

FIG. 1 is a perspective view of a first embodiment of the present invention hereof;

FIG. 2 is a perspective view showing a variety of caps for interchangeable use with a container; and

FIG. 3 is a flowchart showing a method for using the present invention in which a particular color is paired with use with a particular container as desired by the user.

### DETAILED DESCRIPTION OF THE PREFERRED EMBODIMENT

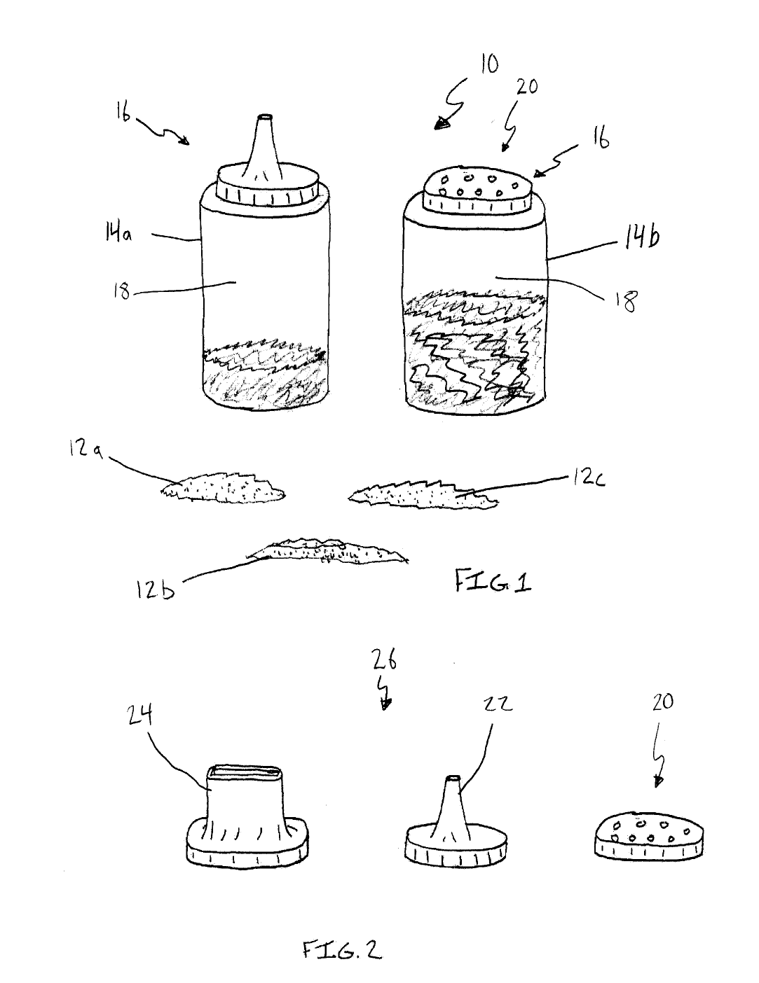

In accordance with the present invention and as shown generally in FIG. 1, there is provided a kit 10 for decorating an object which generally comprises: (a) a plurality of volumes of particulate matter 12a,12b,12c, each volume of particulate matter 12a,12b,12c being uniquely-colored; and (b) a plurality of containers 14a,14b,etc. for storing and dispensing the particulate matter 12a,12b,12c, each container having an opening 16 for dispensing the matter 12a,12b,12c therethrough.

It is contemplated that the present invention comprises a kit 10 for decorating an object, the object being formed from a suitable medium like sand or snow. Each volume of particulate matter 12a,12b,12c included in the kit 10 can be uniquely-colored. The kit 10 can alternatively include several volumes of particulate matter 12a,12b,12c for any particularly popular color. The particulate matter 12a,12b,12c can comprise any suitable non-toxic particulate material which is preferably biodegradable. Preferably, the particulate matter 12a,12b,12c comprises a chalk which has been pulverized or powderized into a particulate matter 12a,12b,12c. Even more preferably, the particulate matter 12a,12b,12c comprises a powderized chalk formed from calcium carbonate, magnesium silicate, calcium sulfate, or the like. In one particular embodiment, the particulate matter 12a,12b,12c can comprise chalk known generically as “sidewalk chalk” which has been pulverized or powderized into a particulate matter 12a,12b,12c.

The particulate matter 12a,12b,12c can be any color, and the kit 10 can include volumes of particulate matter 12a,12b,12c for any color as desired. Preferably, the kit 10 comprises particulate matter 12a,12b,12c in at least each of the primary colors of red, blue, and yellow, although it can contain virtually an unlimited number of volumes of particulate matter 12a,12b,12c in any color imaginable.

The kit 10 also includes the plurality of containers 14a,14b,etc. for storing and dispensing the particulate matter 12a,12b,12c onto the object. Each of the containers 14a,14b,etc. has a substantially closed interior chamber 18 for stowing the particulate matter 12a,12b,12c and an opening 16 for disbursing the particulate matter 12a,12b,12c onto the object. Preferably each of the containers 14a,14b,etc. is formed from a resilient pliable material capable of being repeatedly squeezed or manipulated to exit the particulate matter 12a,12b,12c through the opening 16 and out of the interior chamber 18. Even more preferably, each of the containers 14a,14b,etc. is formed from a transparent or semi-transparent material so that it is apparent what color of particulate material 12a,12b,12c is within each of the containers 14a,14b,etc. For instance, each of the containers 14a,14b,etc. can be formed from any suitable plastic material, such as polypropylene. However, it is to be understood that each of the containers 14a,14b,etc. can comprise any suitable means for storing and disbursing the particulate matter 12a,12b,12c.

The opening 16 on any given container can comprise any suitable mechanism or tool for depositing the particulate matter 12a,12b,12c onto the object. For example, the opening 16 can comprise a plurality of holes 20 to allow a user to dust or sprinkle the particulate matter 12a,12b,12c onto the object. The opening 16 can further comprise an elongated nozzle 22 having a narrowed tip for creating more detailed designs, or an elongated slit 24 for creating stripes or other designs. Is to be understood and contemplated herein that any suitable opening can be used herewith for depositing the particulate matter 12a,12b,12c onto the object. The kit 10 is intended to include a variety of containers 14a,14b,etc. having a variety of openings 16.

Optionally, and as shown in FIG. 2, the kit 10 can include a plurality of caps 26 or covers which each include an opening 16. The caps 26 can be removably secured to any of the containers 14a,14b,etc., and the caps 26 can include the variety of openings 16, or tips, to allow a user to mix and match the colors of particulate matter 12a,12b,12c with the various containers 14a,14b,etc. and openings 16. Each of the caps 26 can be removably secured to each of the containers 14a,14b,etc. using any suitable means which are well known in the art, such as being threadably secured or with snap-fit engagement.

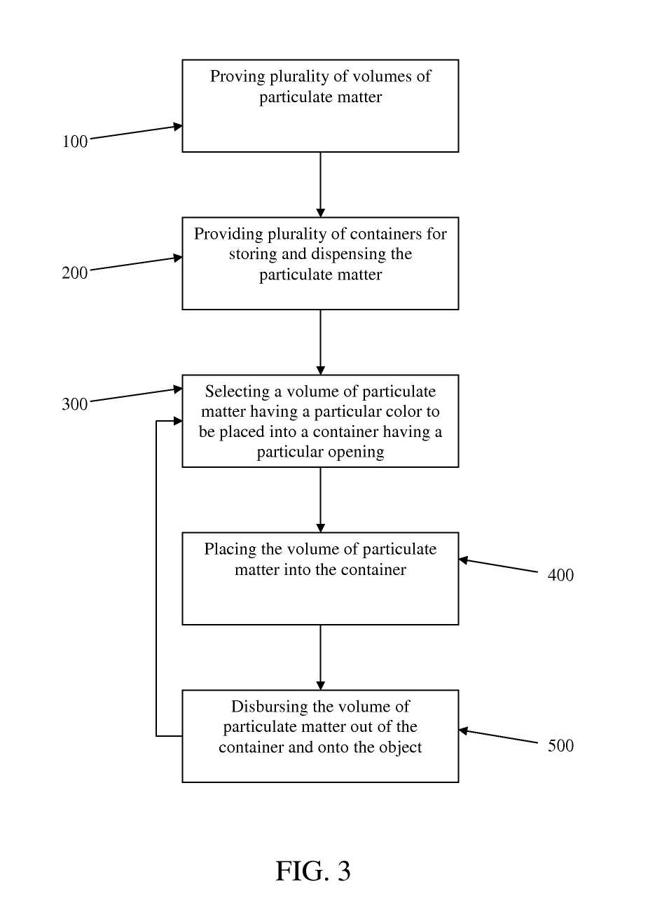

As shown in FIG. 3, the present invention further includes a method for using the kit 10 to decorate the object which generally comprises: (a) a first step 100 of providing the plurality of volumes of particulate matter 12a,12b,12c, each volume of particulate matter 12a,12b,12c being uniquely-colored; (b) a second step 200 of providing the plurality of containers 14a,14b,etc. for storing and dispensing the particulate matter 12a,12b,12c, each container having an opening 16 for dispensing the matter 12a,12b,12c therethrough; (c) a third step 300 of selecting a first volume of particulate matter 12a,12b,12c having a particular color to be placed into a first container 14a having a particular opening 16; (d) a fourth step 400 of placing the first volume of particulate matter 12a,12b,12c into the first container 14a; and (e) a fifth step 500 of disbursing the first volume of particulate matter 12a,12b,12c out of the first container 14a and onto the object.

In a particular example, the kit 10 can comprise volumes of particulate matter 12a,12b,12c having the following colors: red, blue, green, yellow, purple, orange, and black. The kit 10 can further include at least one container 14b in which the opening 16 comprises a plurality of holes 20, this first container being particularly useful for coloring or dusting large sections on the object. The kit 10 can also include at least one container 14a in which the opening 16 comprises an elongated nozzle 22, this second container 14a being particularly useful for coloring smaller areas, such as for performing detail work.

In use, and by way of example, suppose a user would like to decorate a snowman with the kit 10. The user could decide that they would like to color the bottom third of the snowman blue. The user would then fill the container comprising a plurality of holes with blue particulate matter, and then manipulate the container such as by shaking or squeezing to deposit the blue particulate matter onto that section of the snowman. That same process could be repeated to color the middle third of the snowman green, and to color the head of the snowman yellow. The user could then decorate the front of the snowman by coloring buttons thereon by filling the container having a nozzle with a volume of black particulate matter and manipulating the container to deposit the black particulate matter in the proper design onto the snowman. The user can then decorate the snowman with any other desirable features (e.g., lips, eyes, a scarf, etc.) using the same procedure.

The particulate matter 12a,12b,12c is advantageous over the prior art, and particularly any composition which is water-based, because the particulate matter 12a,12b,12c disclosed herein does not cause the snow to melt and therefore does not compromise the substrate upon which the matter 12a,12b,12c is being deposited.

It is to be understood that when the snow melts, the snowmelt will assist in washing away the non-toxic and nonhazardous particulate matter 12a,12b,12c.

It is to be appreciated that the kit 10 can be used to decorate any suitable type of object, such as snow, sand, or the like. It is not intended that the present invention is limited in any way based upon the composition of the object.

Although the kit 10 can have a number of purposes, it is intended primarily to be used by children as a toy for entertainment purposes. But it is understood that it has applicability for anyone desiring to mark such an object. For example, the marking of a snow-covered ground surface by a utility company to indicate the location of utility lines before construction can take place.

According to the invention described above, a kit is provided which includes a plurality of volumes of uniquely-colored particulate matter and a plurality of containers for containing the particulate matter, the containers having a variety of tips or openings for dispensing the particulate matter onto the snow.

What is claimed is:

1. A kit for decorating snow comprising:
(a) a plurality of volumes of particulate matter, each volume of particulate matter being uniquely-colored; and
(b) a plurality of containers for storing and dispensing the particulate matter, each container having an opening for dispensing the matter therethrough.

2. The kit of claim 1 wherein the particulate matter comprises a non-toxic powderized chalk.

3. The kit of claim 1 wherein the opening on each container consists of a plurality of holes or an elongated nozzle.

4. The kit of claim 2 wherein the opening on each container consists of a plurality of holes or an elongated nozzle.

5. The kit of claim 1 including a volume of blue particulate matter, a volume of yellow particulate matter, and a volume of red particulate matter.

6. The kit of claim 2 including a volume of blue particulate matter, a volume of yellow particulate matter, and a volume of red particulate matter.

7. The kit of claim 3 including a volume of blue particulate matter, a volume of yellow particulate matter, and a volume of red particulate matter.

8. A method for decorating snow comprising:
(a) providing a plurality of volumes of particulate matter, each volume of particulate matter being uniquely-colored;
(b) providing a plurality of containers for storing and dispensing the particulate matter, each container having an opening for dispensing the matter therethrough;
(c) selecting a first volume from the plurality of volumes of particulate matter having a particular color to be placed into a first container from the plurality of containers having a particular opening;
(d) placing the first volume of particulate matter into the first container; and
(e) disbursing the first volume of particulate matter out of the first container and onto the object.

9. The method of claim 8 wherein the particulate matter comprises a non-toxic powderized chalk.

10. The method of claim 8 wherein the opening on each container consists of a plurality of holes or an elongated nozzle.

11. The method of claim 9 wherein the opening on each container consists of a plurality of holes or an elongated nozzle.

12. The method of claim 8 including a volume of blue particulate matter, a volume of yellow particulate matter, and a volume of red particulate matter.

13. The method of claim 9 including a volume of blue particulate matter, a volume of yellow particulate matter, and a volume of red particulate matter.

14. The method of claim 10 including a volume of blue particulate matter, a volume of yellow particulate matter, and a volume of red particulate matter.
